(19) United States
(12) Patent Application Publication
(10) Pub. No.: US 2026/0255117 A1
(43) Pub. Date: Aug. 27, 2026

(54) A DEVICE, SYSTEM, AND METHOD FOR INSTALLATION OF AN ACOUSTICAL ELEMENT IN A ROOM

(71) Applicant: SAINT-GOBAIN ECOPHON AB, HYLLINGE (SE)

(72) Inventors: Pierre CHIGOT, Helsingborg (SE); Frédéric ACHARD, Saint-Ouen (FR); Bessaou YALAOUI, Chatou (FR)

(73) Assignee: SAINT-GOBAIN ECOPHON AB, HYLLINGE (SE)

(21) Appl. No.: 18/872,784

(22) PCT Filed: Jun. 15, 2023
(86) PCT No.: PCT/EP2023/066124

§ 371 Date: Dec. 6, 2024

(30) Foreign Application Priority Data
Jun. 17, 2022 (EP) 22179699.8

(51) Int. Cl. H04S 7/00; G03B 29/00; G06F 30/12; G06F 30/13; G06F 119/10

(52) U.S. Cl. CPC H04S 7/30; G03B 29/00; G06F 30/12; G06F 30/13; G06F 2119/10; H04S 2400/11

(57) ABSTRACT

The present disclosure relates to a method for the installation of at least one acoustical element in a room of a building defined by structural surfaces.

### FILED OF THE INVENTION

The present invention generally relates to a device, system, method, a computer-implemented method, and a computer program for the installation of an acoustical element in a room.

### BACKGROUND OF THE INVENTION

Acoustical elements or systems may be installed in rooms in order to alter the acoustical characteristics of the room. Such systems often consist of panels of materials with different acoustical properties. Although panels may have properties with high acoustical reflection this is not common for acoustical absorbent systems. Most commonly acoustical systems only comprise panels with high acoustical absorption. However, a room having a very high level of acoustical absorption is not necessarily desirable as this is a very unnatural environment which for humans is uncomfortable to be in Most often acoustical systems have panels that are placed on the ceiling of the room, but panels are also often placed on the walls as well. Other alternatives are rugs or other materials placed on the floor and freestanding or hanging devices. Panels installed on the ceilings or walls can be placed such that they overlap each other with respect to the ceiling or wall.

Depending on the intended use of a room a different acoustical characteristic is desired. Thus, an acoustical system installed in the room should be such that the desired acoustical characteristics are achieved. Further, both the geometry of the room and the materials of the structural surfaces of the room give rise to different acoustical characteristics.

Thus, the acoustical system may be unique for each room and the installation of the system will therefore also be unique. Further, as a system normally comprises a number of different elements of different shapes and characteristics which are placed at unique positions in the room to achieve a preferred acoustic environment, such installations can be complicated as they might solely adapt to the building's geometry to cover a given area with a modular uniform system. Furthermore, they can be quite time-consuming.

Therefore, there is a need for an improved method of installing an acoustical element or system.

### SUMMARY OF THE INVENTION

In view of the above, it is an object of the invention to provide at least partly an improved method for the installation of an acoustical element in a room that alleviates at least partly or some of the problems with existing installation methods.

According to a first aspect, a method for installation of at least one acoustical element in a room of a building defined by structural surfaces, wherein the at least one acoustical element is intended to be attached to at least one structural surface of the structural surfaces of the room, the method comprising acquiring a room geometry, determining an acoustical characteristic of at least one structural surface defining the room geometry, selecting at least one acoustical element, based on the acoustical characteristic and room geometry, for obtaining a desired acoustical environment in the room, and projecting, by means of a laser projector, an installation guiding projection on the at least one structural surface for the at least one acoustical element for guiding the installation of the acoustical system.

This is advantageous in that this method both is simpler and quicker to install the at least one acoustical element in the room compared to known methods of today. Further, the acoustical element can be placed on a ceiling, wall, floor, or any combination thereof. Further, the structural surfaces of the room may be any of a ceiling, wall, floor, or any other surfaces of objects in the room that is as already installed, such as for example acoustical elements and/or HVAC equipment.

The acoustical element may be an acoustical absorbing element, an acoustical reflective element, and/or an acoustical diffusion element, or any combination thereof. The at least one acoustical element may be a part of an acoustical system, or many acoustical elements may be used to complete an acoustical system. Thus, the methods herein can be used to add one or more acoustical elements in a room to complete or build a complete acoustical system resulting in desired room acoustics.

According to a second aspect, a computer-implemented method for projecting the guiding projection as described above is provided.

According to a third aspect, a computer program having instructions which when executed by an electronic device causes the electronic device to perform the method for projecting the guiding projection as described above is provided.

According to a fourth aspect, a computer-readable medium having stored thereon a computer program according to the method for projecting the guiding projection as described above is provided.

According to a fifth aspect, an electronic device comprising a processor and a memory having thereon a computer program having instructions which when executed by the electronic device cause the electronic device to perform the method for projecting the guiding projection as described above is provided.

According to a sixth aspect, a system for installation of an acoustical system in a room of a building defined by structural surfaces, wherein the acoustical system is intended to be attached to at least one structural surface of the structural surfaces of the room, the system comprises an electronic device according for projecting the guiding projection as described above, the electronic device configured to communicate with a server, and a server, configured to communicate with the electronic device, is provided.

Further examples of the disclosure are defined in the dependent claims, wherein features for the seventh and subsequent aspects of the disclosure are as for the first to sixth aspects mutatis mutandis.

Some examples of the disclosure provide for an installation guiding projection comprising at least one of fixation points, size, an identification number, a relationship, a context, cable suspension length, a position associated with at least one of the acoustical elements, electrical wiring, ventilation ducts, and/or building elements.

Some examples of the disclosure provide for projecting an installation guiding projection in a sequence of a plurality of projections for guiding step-by-step an installation of an acoustical element.

Some examples of the disclosure provide for projecting a verification projection of at least one of the acoustical elements subsequent to projecting a guiding projection.

Some examples of the disclosure provide for a verification projection is indicative of a position of at least one of the acoustical elements and that the position of the acoustical element is in accordance with an installation layout.

Some examples of the disclosure provide for determining an absorption coefficient, airflow resistance, air flow resistivity, diffusivity, and/or diffusion of the at least one structural surface of the room.

Some examples of the disclosure provide for a desired acoustical environment of the room comprises a reverberation time, speech clarity, auditory sound strength, and/or sound propagation.

Some examples of the disclosure provide for acquiring a room geometry comprises scanning the room and/or retrieving the room geometry data from a building information model (BIM).

Some examples of the disclosure provide for calculating, based on acoustical characteristics and a room geometry a desired acoustical characteristic of an acoustical element for obtaining the desired acoustical environment in the room.

Some examples of the disclosure provide for a laser projector being self-calibrating of an installation guiding projection on at least one structural surface.

Some examples of the disclosure provide for an acoustical element being an acoustical absorption element.

Throughout this application, the use of a laser projector is to be understood as a laser projector capable of projecting multiple points at a time, such as lines or patterns. The laser projector may also be self-leveling and/or self-installing, thus the need for any physical setup in a room with additional markers is not needed.

Further scope of applicability of the present disclosure will become apparent from the detailed description given below and the accompanying drawings. However, it should be understood that the detailed description and specific examples, while indicating preferred variants of the present inventive concept, are given by way of illustration only, since various changes and modifications within the scope of the inventive concept will become apparent to those skilled in the art from this detailed description.

Hence, it is to be understood that this inventive concept is not limited to the particular steps of the methods described or parts of the systems described as such methods and systems may vary. It is also to be understood that the terminology used herein is for the purpose of describing particular embodiments only and is not intended to be limiting. It must be noted that, as used in the specification and the appended claim, the articles “a”, “an”, “the”, and “said” are intended to mean that there are one or more of the elements unless the context clearly dictates otherwise. Thus, for example, reference to “a device” or “the device” may include several devices, and the like. Furthermore, the words “comprising”, “including”, “containing” and similar wordings do not exclude other elements or steps.

### BRIEF DESCRIPTION OF THE DRAWINGS

The aspects of the inventive concept, including its particular features and advantages, will be readily understood from the following detailed description and the accompanying drawings, in which:

FIG. 1 is a flowchart for a method for the installation of an acoustical system based on an installation guiding projection.

FIG. 2 illustrates an installation guiding projection in a ceiling.

FIG. 3 illustrates an example of an installation guiding projection based on a laser layout projection system.

FIG. 4 conceptually illustrates different steps in an installation of an acoustical system based on an installation guiding projection.

### DETAILED DESCRIPTION

The present inventive concept will now be described more fully hereinafter with reference to the accompanying drawings, in which preferred variants of the inventive concept are illustrated and discussed. This inventive concept may, however, be embodied in many different forms and should not be construed as limited to the variants set forth herein; rather, these variants are provided for thoroughness and completeness and fully convey the scope of the inventive concept to the skilled person. Like reference numerals refer to like elements throughout the description.

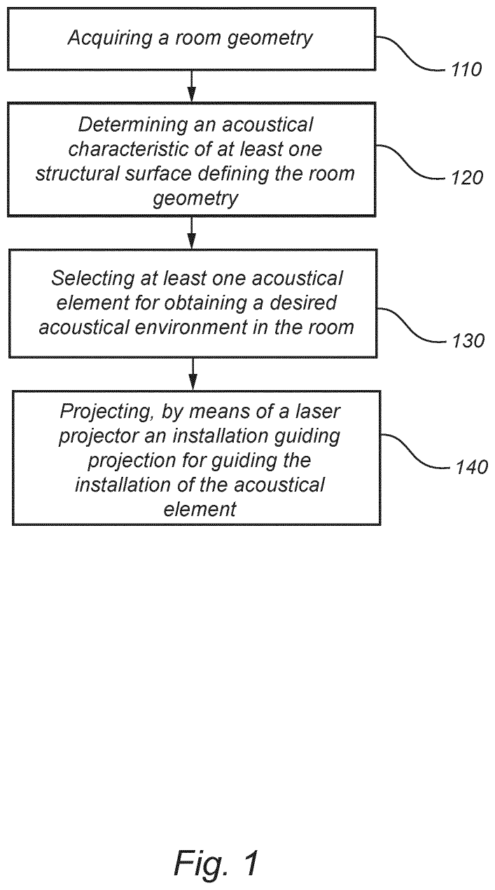

FIG. 1 is a flowchart of a method for the installation of at least one acoustical element in a room of a building defined by structural surfaces. The at least one acoustical element is intended to be attached to at least one structural surface of the structural surfaces of the room. The method comprises acquiring a room geometry 110, determining an acoustical characteristic of at least one structural surface defining the room geometry 120.

The acquiring of the room geometry 110 can be performed by for example scanning the room and/or by retrieving the room geometry data from a building information model (BIM). The acquiring of room geometry 110 and/or determination of the acoustical characteristics of the room 120 can be performed by for example a 3D scanning device such as a total station, laser scanning device, extracted from an image and/or a set of images.

The structural surfaces can be any one of a ceiling, floor, wall, or any combination thereof.

In other words, a digital twin of the room is created that comprises the room geometry and the acoustical characteristics of the structural surfaces defining the room.

The information in the digital twin can be acquired physically and/or digitally. For example, by measuring by using a device as discussed above and/or obtained from the BMI, and/or image.

Other sources may also be used for creating the digital twin and populating information of the digital twin, such as architectural drawings, occupancy information, acoustical databases, and/or material databases.

It would also be possible to combine the physical measurements with information from the building information model to create, verify and/or further improve the digital twin or digital model. For example, the BMI can be used to obtain the room geometry and physical measurements can be used to determine the structural surfaces of the room, which then are combined in the digital twin for further use.

The method further comprises selecting at least one acoustical element, based on the acoustical characteristic and room geometry, for obtaining a desired acoustical environment in the room 130.

Based on the desired acoustical environment of the room, which can be chosen by for example a client or due to standards and requirements for a specific room type such as a classroom, when the acoustical system is installed, the acoustical system is calculated, and optimized given desired parameters connected to the desired acoustical environment. The desired connected parameters can be various room acoustic parameters such as for example reverberation time, speech clarity, and/or sound strength.

Based on the available acoustical elements and the acoustical elements property, the selection 130 is optimized to achieve a good fit to the desired acoustical characteristics.

The method also comprises projecting, by means of a laser projector, an installation guiding projection on the at least one structural surface for the at least one acoustical element guiding the installation of the at least one acoustical element 140.

The above steps may be performed separately and/or in combination both in time and/or location. For example, the acquiring of the room geometry 110 can be performed by a designer for the acoustical system by going to the room and measuring. The designer may then determine 120 and select the acoustical element 130 on a computer in the designer's office by himself or with the aid of the computer for later projection of the installation guiding projection.

In another example, the designer has brought a tablet and determines 120, and selects the acoustical element 130 in the room. In another example, the designer acquires the room geometry 110 from a building information model, determines 120, and selects the acoustical element 130 at an office.

When the at least one acoustical element is selected 130 the installation guiding projection, can be projected 140, by means of a laser projector.

The steps above can be used for the installation of one acoustical element, or a plurality of acoustical elements making up an acoustical system. The acoustical element or acoustical system can in some examples comprise only acoustical absorption elements, or in other examples at least one absorbent element.

Hence, the projection of the installation guiding projection on at least one of the structural surfaces of the room allows for an improved and quicker installation of the acoustical element. Further, non-trivial installations, characterized by overlaps, offsets, and misalignments of acoustical elements, are made manageable on-site. The method discussed herein may also be used for the installation of gypsum boards in buildings.

Additionally, for example by using the laser projector for projecting the installation guiding projection the installers have a blueprint that is highly visible for the installers on the structural surface and easily controllable to be used in different environments. Further, an advantage of using the laser projector is that there is a possibility to manually and/or automatically scale and set the display plan of the installation guiding projection, self-calibrating laser projector. This means that the desired information of the installation guiding projection can be projected in or close to life-size. This life-size projection is advantageous since small errors in the projection might cause expensive or catastrophic errors. For example, a cumulated error of a few millimeters can become centimeters, resulting in the installer having to drill into a power cable or similar when preparing fixation points for the acoustical element.

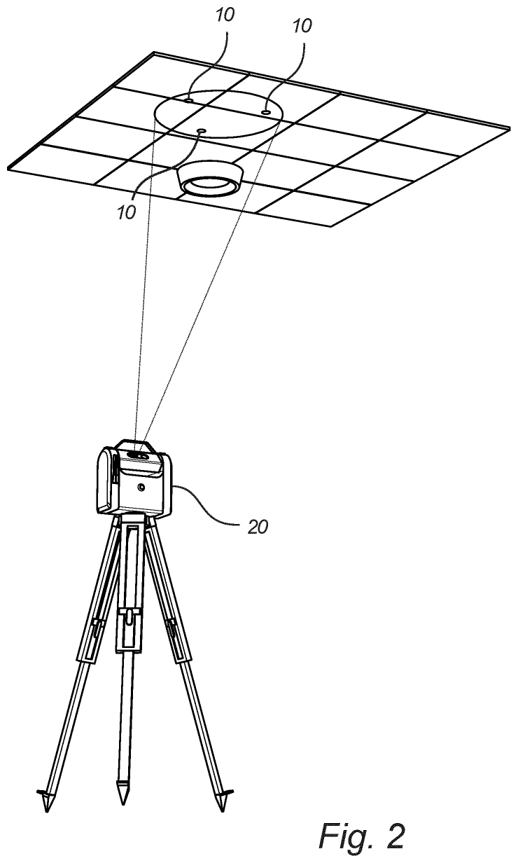

Illustrated in FIG. 2 is an electronic device 20 comprising a processor and a memory having thereon a computer program having instructions which when executed by the electronic device 20 cause the electronic device 20 to perform the method for installation of at least one acoustical element in the room. In the illustration, the electronic device 20 comprises the laser projector and the installation guiding projection comprises a grid and three markers 10 showing where to put in fixers for the acoustical element in the ceiling of the room.

It is also illustrated in FIG. 2 that a light fixture in the ceiling and the light fixture should be avoided for the fixers but it could also be used as a reference point for the installation guiding projection. Other reference points can of course also be used so that the installation guiding projection becomes as correct as possible throughout the installation. For example, the reference point may be the same as the setting out reference point used to create the walls and other elements of a building. However, the setting out reference point may only be used when installing acoustical elements in new buildings that are not completed.

When installing acoustical elements in more or less completed buildings, as discussed above, other types of known elements may be used as light fixtures, HVAC, electrical components, pillars, bearing walls and so on that gives the installer and the installation method a known fixed point for that floor. In other examples, an element in a room or simply the wall, or a corner of a room can be used as a reference point.

In other words, the complexity of the installation of the acoustical element can dictate the use and selection of the reference point. If it is a complex installation for a large volume with a lot of other components that need to be accounted for, imagine an entrance of a large company, having electricity, HVAC, sprinklers, and more running in the ceiling, then the reference point is crucial so that there is no or less conflict with existing components. If then on the other hand there is an installation in a single room with a simple ceiling without any components, then the corner of the room could be a good reference point for the installation of the acoustical element.

As discussed above, the illustration in FIG. 2 illustrates three fixation points 10, but other information may also be projected such as size, an identification number, a relationship, a context, cable suspension length, a position associated with at least one of the acoustical elements, electrical wiring, ventilation ducts, and/or building elements. Further, the installation guiding projection may in addition and/or alternatively also comprise, HVAC installation information, luminaire or lighting information, wiring information for the luminaire, audio, electrical, and so on.

All this information may be projected at the same time or at different times. The projected information may be used to find for example reference points, as discussed above. It would also be possible to align the projection by using for example two projected components such as a light fixture and a ventilation outlet. Further, the projected information makes it easier for the installer to verify that other components don't conflict with the acoustical installation, and if the acoustical installation is complex, makes it much easier by telling the installer for example which cable length to be used for that fixation point and what direction and relation that acoustical element may have to its neighbors.

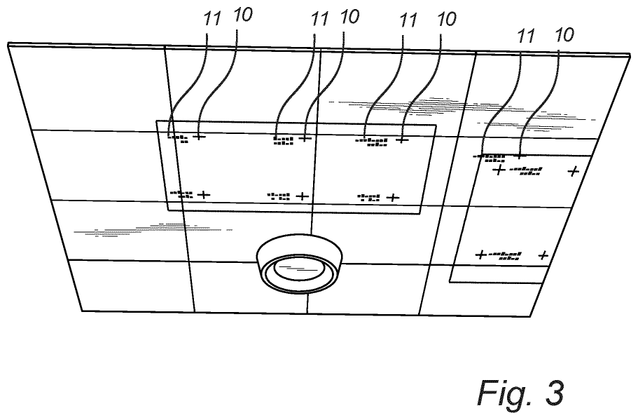

Another example of what could be included in the installation guiding projection is illustrated in FIG. 3 which illustrates the fixation points 10 and an identification number 11 associated with at least one of the acoustical elements. FIG. 3 illustrates the context of two acoustical elements and their placement around the light fixture. This can be seen by the outlines of the elements, one being arranged in a left-to-right and the other in a top-to-bottom plane of the illustrated ceiling. It would also be possible to include in the installation guiding projection a surface pattern of the acoustical element such that the surface pattern is aligned in a desired way with for example light sources or windows in the room.

By projection for example the fixation points 10 of the acoustical element the installer can easily see where to drill the fixation points and then later put in fixings, such as soffit fixings. Further, when the projection additionally comprises the identification number 11, the installation of the correct acoustical element in that place is aided. Thus, if there is a complex installation of the acoustical system in for example a specific 3D shape or with many different acoustical elements, the acoustical elements can be individually marked both on the acoustical element itself and in the ceiling so that the installer easily can hang them in their correct position to get the desired acoustical environment.

To further aid the installer, the projection of the installation guiding projection may be projected in sequence in time as discussed above, or in addition or alternative, also along the room in a plurality of projections for guiding step-by-step the installation of the acoustical elements in the room. In this way, the installation may be guided from a starting area to a finish area in the room. Thus, the installer gets simpler step-by-step instructions on how to combine the acoustical elements into the complete acoustical system. Further, the sequential projection could also be used to project for example the context by projecting different heights, slopes, and/or orientations for different acoustical elements.

Further, the projection may comprise a verification projection on at least one of the acoustical elements subsequent to projecting the guiding projection. Wherein the verification projection is indicative of the position of the at least one of the acoustical elements in accordance with the installation layout. In this way, the installer can easily verify if the installation is correct. It would also be possible to verify that other components are in their correct place according to for example electrical schematics, or architectural drawings.

In some examples, the determining of the acoustical characteristics of the structural surfaces comprises determining an absorption coefficient, airflow resistance, air flow resistivity, diffusivity, and/or diffusion of each structural surface of the room. Any of the acoustical properties may be determined by physically measuring and/or assigning from a database comprising acoustical characteristics of different structural surfaces. Further, the desired acoustical environment of the room may comprise a reverberation time, speech clarity, auditory sound strength, and/or sound propagation.

These are well-known acoustical properties of a room and/or acoustical element and can be obtained by many known methods such as for example ISO 3382, ISO 354, ISO 12354, and/or ISO 9053.

The method may in some examples further comprise calculating, based on the acoustical characteristics and room geometry, a required acoustical characteristic of the acoustical system for obtaining a desired acoustical environment in the room. The calculation of the required acoustical characteristics may be performed before selecting at least one acoustical element 130, based on the acoustical characteristic and room geometry, for obtaining a desired acoustical environment in the room for further improving the selection process. The calculations for the required acoustical characteristics may be performed at the installation by the electronic device 20, other local devices or computers, and/or remotely. The selection of where to perform the calculations may be based on the complexity, available computational bandwidth, and so on. Thus, in an example, the electronic device 20 is part of a system for the installation of at least one acoustical element in a room of a building defined by structural surfaces. The electronic device 20 may then be configured to communicate with a server, and the server is configured to communicate with the electronic device 20. Again, this allows for remote connection, updates, and communication with and/or between different parties and the electronic device 20.

In some examples, the above steps and/or methods for projecting an installation guiding projection of at least one acoustical element in a room of a building is at least partly or fully computer-implemented. This allows for the projection to be easily transferred between different parties such as the designer of the acoustical element and the installer. It would also allow for cooperation wherein different parties in a building could add their relevant information such as electricity, HVAC, etc, for later projection.

Further, the information or data comprising the installation guiding projection may be projected by for example a wired or wireless connection to the laser projector. It would also be possible to store the installation guiding projection on a memory card or other storage means for transferring the installation guiding projection to the laser projector.

In some examples, there is therefore a computer program having instructions which when executed by an electronic device cause the electronic device to perform the method projecting an installation guiding projection of at least one acoustical element in a room. The computer program may for example be stored on a computer-readable medium, a server, and/or in a cloud.

### Example of an Acoustical Installation Process

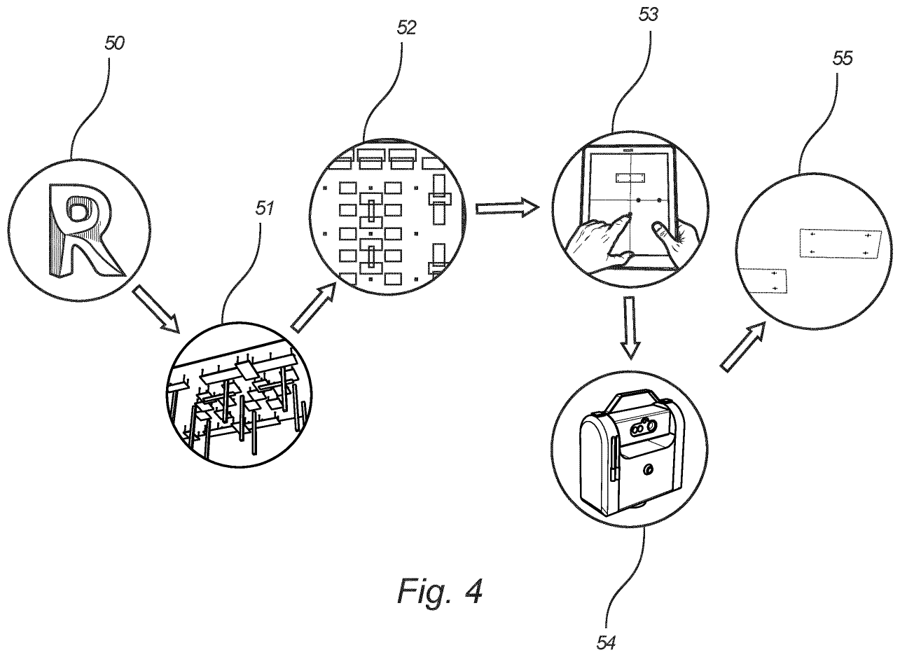

Illustrated in FIG. 4, is an example of a flowchart of an installation wherein the building information model 50 is used to establish the digital model of the room (a digital twin of the room). The digital model has a size and resolution that is high enough to fulfill the needs of the purpose of installing acoustic ceilings and wall panels. For example, acoustic ceilings and wall panels show tolerance at the installation of approximately 2 to 15 mm, and the digital model therefore preferably has at least that resolution.

The geometry and acoustical characteristics of the acoustical elements are sorted and structured in a database allowing for multiple and parallel calculations of the acoustical elements 51. For example, the calculations may be based on that the geometry and acoustical characteristics are kept constant whereas the acoustical elements are variable.

In some examples, after a few iterations, the determining of the desired configuration is achieved, defined as an acoustical element positioned on a certain surface of the room and in a certain quantity. The surface to be covered by the acoustical elements is then included in the digital model and a digital process is then activated for that surface to automatically select the at least one acoustical element and create an acoustical system in its entirety 52.

In some examples the acoustical system is based on soffit fixings in a 1200×1200 grid, main runners along the length of the room, perimeter tiles >300 mm, and cross tees 1200 at 1200 cc between the main runners. Based on the above, every acoustical element and the associated elements can be included in the digital model and serve as input data to a client order.

Further, either in parallel or in sequence, an impulse response at a given point of the room can be calculated. The impulse response may be convoluted with an anechoic recording of a voice or a sound source in order to generate for example an ambisonic sound file that can be presented in a stereophonic manner to a client for experiencing the treated room before the room is being installed.

Additionally, the digital model comprising the geometry, the surface texture of the different material types forming the room, and their optic properties can be used to calculate a visual rendering of the room in a given lighting condition. Several configurations can be generated in order to compare and validate the visual design such as for example the interplay of grazing light on the ceiling or the effect of a certain luminaire design.

The visual rendering and audio rendering can then also be combined and experienced in a virtual reality device serving for a full validation of the acoustical system.

Following approval of the acoustical system by the client an installer is appointed. The installer is then given access to the digital model, whereby the installer can use the digital model for simulation and testing the planning and phasing of the project 53. Further, it would also be possible to simulate and test any logistics and supply, based on size, form factor, and quantity of the different cartons to be delivered or completion of other trades' work.

Following, a selection is made of a starting zone of where to start the installation of the acoustical system. Within the starting zone, a sequencing is chosen, defining in what order the acoustical elements are to be installed. With the help of for example numbering, contextualizing information, color codes, soffit fixing points, panel ID, cable length, and other tags, the digital model can be further improved.

The installer can then bring the digital model and upload or stream the digital model to the laser projector 54 such that the information in the digital model is then projected onto the rooms' surfaces 55. For example, by projecting soffit fixing points, panel ID, or cable length. The information can be presented superposed or separated.

The projection is, as discussed above, from the laser projector which is calibrated and leveled, self-leveled, compared to a virtual layout grid system (reference points) and the laser projector projects a 1/1 representation of the digital model. By positioning the laser projector in space at dedicated points, there is consistency in the projection. This also allows for the device to be moved around to secure a good contrast with the desired accuracy.

Thus, the information of the digital model being presented directly on the surface of the building removes a need for the installer to flip back and forth from a plan drawing “seen from above” whilst looking at for example the ceiling during installation, from below.

Further, the information being projected can be modified on-site in order to handle any discrepancies between the digital model and reality. This could for example be that the installer changes elements of the layout, in formation or as singular elements which then can be translated and/or rotated in order to be moved into a suitable position and projected more or less in real-time. The same can be applied in the case of conflicts between soffit fixings and expansion joints between concrete elements of the ceiling and in the case of using a prefabricated slab for the concrete elements. Other building equipment can also be interfering with the desired installations, such as for example HVAC, electrical, water, and so on.

The installer can also easily verify and control for example the identity of the panel (type, size, color) and the position of the acoustical element (altitude/ceiling height, slope relation to original digital model).

Additionally, document discrepancies can be identified and reinput into the digital model so that becomes a more accurate digital twin of the actual room.

Furthermore, while some examples described herein include some, but not other features included in other examples, combinations of features of different examples are meant to be encompassed and form different examples, as would be understood by those skilled in the art. For example, in the following claims, any of the claimed embodiments can be used in any combination.

Furthermore, some of the examples are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus is an example of a means for carrying out the function performed by the element.

1. A method for installation of at least one acoustical element in a room of a building defined by structural surfaces, wherein the at least one acoustical element is intended to be attached to at least one structural surface of the structural surfaces of the room, the method comprising:
acquiring a room geometry;
determining an acoustical characteristic of at least one structural surface defining the room geometry;
selecting at least one acoustical element, based on the acoustical characteristic and room geometry, for obtaining a desired acoustical environment in the room; and
projecting, by means of a laser projector, an installation guiding projection on the at least one structural surface for the at least one acoustical element for guiding the installation of the at least one acoustical element.

2. The method according to claim 1, wherein the installation guiding projection comprises at least one of fixation points, size, an identification number, a relationship, a context, cable suspension length, a position associated with at least one of the acoustical elements, electrical wiring, ventilation ducts, and/or building elements.

3. The method according to claim 1, wherein projecting the installation guiding projection comprises projecting in sequence a plurality of projections for guiding step by step the installation of the acoustical element.

4. The method according to claim 1, further comprises projecting a verification projection on at least one of the acoustical elements subsequent to projecting the guiding projection, wherein the verification projection is indicative of the position of the at least one of said acoustical elements in accordance with an installation layout.

5. The method claim 1, wherein the determining of the acoustical characteristics of the at least one structural surface comprises determining an absorption coefficient, airflow resistance, air flow resistivity, diffusivity, and/or diffusion of the at least one structural surface of the room.

6. The method according to claim 1, wherein the desired acoustical environment of the room comprises a reverberation time, speech clarity, auditory sound strength, and/or sound propagation.

7. The method according to claim 1, wherein the acquiring of the room geometry comprises scanning the room and/or retrieving the room geometry data from a building information model (BIM).

8. The method according to claim 1, further comprises calculating, based on the acoustical characteristics and room geometry the required acoustical characteristic of the acoustical element for obtaining the desired acoustical environment in the room.

9. The method according to claim 1, wherein the laser projector is self-calibrating the installation guiding projection on the at least one structural surface.

10. The method according to claim 1, wherein the acoustical element is an acoustical absorption element.

11. A computer-implemented method for projecting an installation guiding projection of an acoustical element in a room of a building according to claim 1.

12. A computer program having instructions which when executed by an electronic device causes the electronic device to perform the method according to claim 11.

13. A computer-readable medium having stored thereon a computer program according to claim 12.

14. An electronic device comprising a processor and a memory having thereon a computer program having instructions which when executed by the electronic device cause the electronic device to perform the method according to claim 11.

15. A system for installation of an acoustical element in a room of a building defined by structural surfaces, wherein the acoustical element is intended to be attached to at least one structural surface of the structural surfaces of the room, the system comprises:
an electronic device according to claim 14, the electronic device configured to communicate with a server, and
a server, configured to communicate with the electronic device.
